(19) United States
(12) Patent Application Publication
(10) Pub. No.: US 2020/0311691 A1
(43) Pub. Date: Oct. 1, 2020

(54) SYSTEM AND METHOD FOR OPTIMIZING THE DELIVERY OF SERVICES

(71) Applicant: Joseph Tessel, Riverdale, NY (US)

(72) Inventor: Joseph Tessel, Riverdale, NY (US)

(21) Appl. No.: 16/825,744

(22) Filed: Mar. 20, 2020

Related U.S. Application Data
(60) Provisional application No. 62/827,740, filed on Apr. 1, 2019.

(51) Int. Cl. G06Q 10/10; G06Q 30/02; G06Q 30/04

(52) U.S. Cl. CPC G06Q 10/1095; G06Q 30/0251; G06Q 30/04; G06Q 30/0201

(57) ABSTRACT

A time management system includes a plurality of customer communication devices (CCD), each CCD is configured to allow a customer to place a voice or data communication to a plurality of providers of services. The voice or data communication is associated with a scheduling request requesting the scheduling of a voice call session with the service providers or the rendering by the service providers of a desired service to the customer. The voice or data communication includes customer availability time period or periods. A plurality of service providers communication devices (SPCD) are provided, where each is configured to receive the voice or data communication and automatically to respond thereto by providing a call back time slot or a service performance time period, which takes into account said customer availability time period or periods, and customer information across various devices and services.

### CROSS-REFERENCE TO RELATED APPLICATION

The present non-provisional patent application claims the benefit of and priority to U.S. Provisional Patent Application No. 62/827,740, filed Apr. 1, 2019, by Joseph Tessel, and entitled “SYSTEM AND METHOD FOR OPTIMIZING THE DELIVERY OF SERVICES,” the entire contents of which are incorporated herein by reference.

### BACKGROUND OF THE INVENTION

The present disclosure is directed to systems and software for facilitating the delivery of services and, more particularly, to a system that synchronizes delivery of services with the calendars of clients, customers or patients, to be utilized by service or product providers in scheduling, rescheduling particular clients/customers or patients, and filling available slots most efficiently from an available pool of clients/customers or patients, so that provided services or revenues are maximized, subject to constraints of customer satisfaction (provider-defined) and other considerations (provider-defined).

In certain embodiments thereof, the inventive system builds on and/or utilizes the teachings in U.S. Pat. No. 9,514,424 to Kleinbart, et al., of Dec. 6, 2016, the full contents of which are incorporated by reference herein. The Kleinbart system, very broadly, is a system and method that utilizes one or more processors that prioritize various tasks and action associated with a user, in accordance with the described optimization algorithm. A to-do list is provided that includes the prioritized tasks. Electronic data event information representing send/receive data associated with the various tasks is received and the tasks and some of the actions are reprioritized. The to-do list is dynamically modified based on various prioritization schemes and continually updated or receipt of new data and actions.

The proposed system will serve as a stand-alone system for service providers (to collaborate with customers), or will integrate into a system such as the system cited above (Kleinbart et al.).

Customer service/help desk calls (inbound service calls by e-mail, phone or other communication), and analog service providers (e.g. dentists, refrigerator repairpersons, plumbers) both suffer from the inability to provide mutually convenient services, which are time-wise better coordinated. Currently, the service providers have the upper hand, but the scheduling process frequently leaves customers dissatisfied and resentful. Much time is wasted by customers or clients being kept on hold, or waiting for callbacks from service providers.

On the other hand, many service providers (e.g. physicians, dentists, hairdressers, restaurants etc.) suffer from missed appointments or bookings.

Clients, patients and customers all have problems synchronizing their schedules, or rearranging schedules to minimize wasted time and to receive service most conveniently.

The present invention and system is distinguishable from main e-commerce systems that focus on connecting customers to service providers, and is distinct from sellers of physical products. Thus, the services provided and/or described at the website address: www.one-to-one_service.com purports to be a leading provider of digital customer service and marketing software (iService®) that is said to be easy implement and easier to use. The iService® website claims that it is able to route and manage customer inquiries, connect agents with website visitors via live chat, capture a complete history of every customer interaction, provide a self-help website and that it includes integrated e-mail marketing capabilities.

Nonetheless, the known systems has not provided, suggested or recognized the need for the specific technology and methodology that has been identified above, namely, the need to synchronize schedules between customers requiring service and service providers.

### SUMMARY OF THE INVENTION

Accordingly, it is an object of the present invention to provide a system that is able to synchronize the timing and accommodate the scheduling and rescheduling of telephone calls or data interchanges between customers and service providers, in a manner which avoids the drawbacks of the prior art. It also draws up stored User information to expedite the process and allow for a more positive experience for both Users and Service Providers.

In one form thereof, it is an object of the present invention to provide a standardized system that can be utilized across the entire service providing sector that systemizes and standardizes the automated telephoning, e-mailing, texting or other electronic communication for and/or the setting up and scheduling the services being provided to customers and the calling process relating thereto.

The instant disclosure details a new model for customer-service/help desk calls. In a typical queuing model embodiment, clients, patients and customers are put on hold, or clients, patients and customers IM (Instant Message) with the service desk and have to wait in line, and then provide personal information—sometimes the same information across multiple systems. In an aspect of the inventive embodiment, the system informs clients, patients and customers how long the expected wait is and, if necessary, will give them the option of leaving or entering a call back number, different than the recognized or stored number, so they can stop waiting on hold. The same system informs Service Providers of their customer's information.

The system will simply call back when the customer gets to the front of the queue. The proposed system facilitates and improves the customer/service-provider experience in that the customer/client/patient is able to indicate an exact time for most convenient call-back, or perhaps an availability window, and/or indicate the times or periods when the customer will not be available. The vendor system would manage this on the vendor side, but possibly in a more advanced scenario of the above mentioned Kleinbart et al system on both sides of the call, coordinating and evolving an ideal call-back time that is optimal for the service provider and for the customer needing service.

Added to this is an improvement in the business process in which one is able to link his/her customer service or purchase record to the call (online in IM window, or via IVR), so that when called back the customer is recognized, and is not asked to repeat previously solicited or provided information, such as model number, serial number, history etc., which the service provider shall have already recorded and stored relative to the given transaction. This information is already displayed to the person servicing the interaction when the proposed system determines the call-back should be done. Additional knowledge-based analysis of the particular device and the nature of the problem are provided which reduces the likelihood that the person calling back has the wrong skill-set, another common problem.

The financial business case for the above is compelling for an industry with massive scale, as it enables call-center staffing to be better managed

Integration with a Kleinbart et al. system will also alert either side in providing/receiving either party's late or potentially early arrival, or new availability or new lack of availability, linking to arrival updates through the Kleinbart et al. system or, from Google Map and other alerts/monitoring systems, on either or both of the provider/customer locations, etc.

In one embodiment of the invention, the software comprising the Kleinbart system is provided at the vendors' servers and on mobile or stationary computing devices at the customers' end. These systems are enhanced so that the task scheduling functions at both ends are in communications with each other to evolve an optimal service visit day or time or an optimal service providing date/time taking into account the schedules of both the service providers and the customers. In another embodiment it is a service-provider only installation, with which a customer interacts to manually input his/her time preferences.

In a further developed version of the invention, the choosing of the time for delivering of services can include a reward system that customers may opt for, so that service providers may reward customers who agree to be serviced during off-peak hours or times, for evolving for services providers' better flow works and efficiencies.

The foregoing and objects of the invention may comprise in preferred embodiments a time management system that includes a plurality of customer communication devices (CCD), each said CCD being configured to allow a customer to place a voice or data communication to a plurality of providers of services, said voice or data communication being associated with a scheduling request requesting the scheduling of a voice call session with said service providers or a rendering by the service providers of a desired service to said customer; said voice or data communication including customer availability time period or periods; and a plurality of service providers' communication devices (SPCD), each said SPCD being configured to receive said voice or data communication and to respond thereto by providing a call back time slot or a service performance time period, which takes into account said customer availability time period or periods Preferably, the plurality of customer communication devices communicate directly with said plurality of service providers communication devices, co-ordinated, facilitated and executed by the system contemplated in this application. Further, the SPCD is configured to provide to said CCDs information identifying the length of time to be expected before receiving a call back number. Preferably, the SPCDs include a facility for calling back said CCDs during said call back time slot. Also, the communication between said CCDs and said SPCDs is through an IM window or via IVR. Preferably, there is included a facility that configures the SPCDs to receive and store personal profile data associated with said CCDs and historical information about the customers.

In another preferred embodiment, there is included an intermediary central server that mediates communications between said CCDs and said SPCDs and the CCD devices comprise APP software that is standardized across said customers, but which enables customization by specific customers to suit each customer's specific needs or requirements. Preferably, the SPCDs are controlled by APP service provider software that is standardized across said SPCDs, but which enables individual service providers to tailor and configure the APP service provider software to suit individual needs of said service providers.

In an embodiment, the intermediary central server comprises a software controlled system (SCS) that provides a plurality of server functions applicable to said CCDs and to said SPCDs and the functions include registering customers and service providers with said central server (CS) and storing and retrieval of customer history information. The functions include the storing of customer history information including accounting and billing for creating billings to service providers for use of the central server and providing to customers appointment notifications.

Preferably, the functions include providing to service providers information that informs the SCS of the time proximity of a given customer to the location of the service provider and advertising services of individual service providers. The functions also include a facility that develops statistical information about the time latency between the placement of a call to a service provider and the providing of the time slot for either a telephone call or for a service relative to each service provider that has opted that such data should be developed and rating system that enables customers to rate the service provider after such service has been rendered in an anonymous manner and to provide this information to the service provider only.

Other features and advantages of the present invention will become apparent from the following description of the invention which refers to the accompanying drawings.

### BRIEF DESCRIPTION OF THE DRAWINGS

FIG. 1 is a block diagram showing the invention in accordance with an embodiment thereof.

FIG. 2 is a prior art drawing showing a basic computer and web system that are usable with the invention.

FIG. 3 is another block diagram and layout of another concept in accordance with the present invention.

FIG. 4 is a first block diagram setting forth various functionalities of the system of the present invention.

FIG. 5 is a further block diagram setting forth software constituents and system functionalities in accordance with the present invention.

FIG. 6 is another block diagram identifying functionalities associated with the call scheduling aspect of the invention.

### DETAILED DESCRIPTION OF EMBODIMENTS OF THE INVENTION

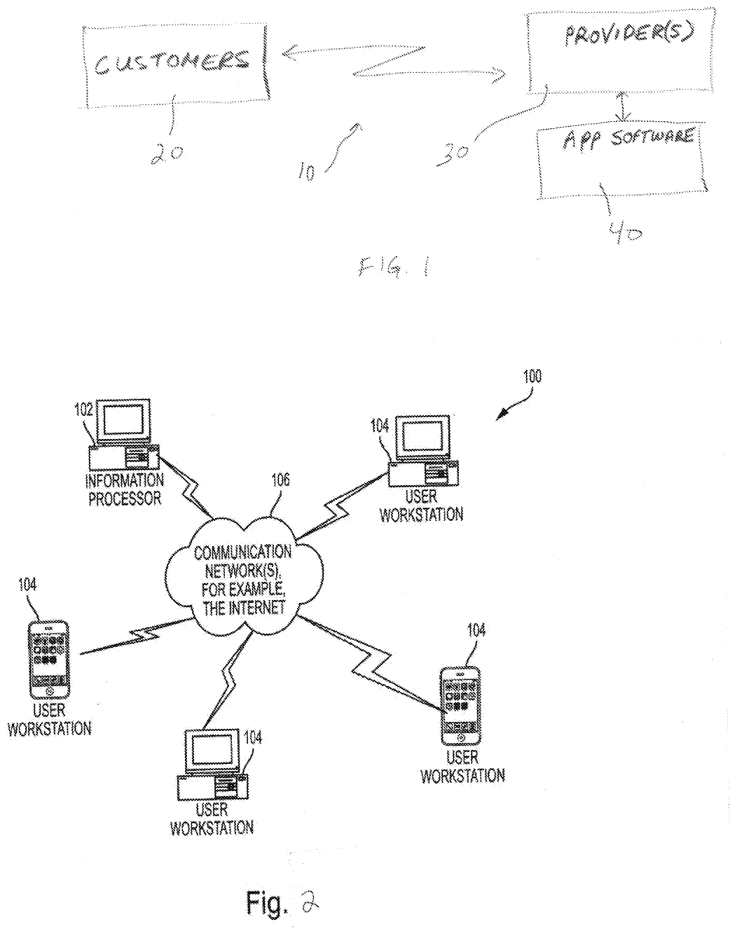

With reference to the drawings, FIG. 1 is a basic block diagraming showing the relationship between customers 20 requiring specific services who communicate through telephone lines or data lines to service providers 30, who operate APP software 40 that allows the overall system 10 to achieve certain objects of the present invention.

FIG. 2 is a basic hardware and system layout described in the aforementioned Kleinbart U.S. Pat. No. 9,514,424, showing a system 100 that has a main information processor 102 that communicates over a communication network 106 with user workstations 104.

This basic system, operating with APP software 40, is able to provide the functionality mentioned above including the APP software 40 providing information to the customer about how long the expected wait is and/or providing the option of leaving or entering a callback number. APP software 40 and the associated system will call back the customer at a convenient time for the customer. The system represented and the functionality provided by APP software 40 facilitates and improves the customer/service/provider experience in that the customer/client/patient is able to indicate an exact time for a most convenient call-back and optional availability window and indicate the times and periods when the customers will not be available for a call-back. The communication can be through an IM window or via IVR. When a customer calls, the APP software 40 may have already in its record previously stored information about the customer, the particular product, model number, serial number or repair history from prior visits. In the case of a medical office, the medical record is made available. The APP software 40 may include a reward system providing certain rewards or benefits to customers who are willing to receive services during off peak hours.

In the embodiment represented by FIG. 1, the arrangement is to allow the customers direct contact to a specific service provider which is outfitted with its own APP software 40, configured for the specific provider. Thus, a medical office will have one type of APP software, while an automobile repair service will have another type and a brokerage firm will have yet another type and so on. A system of this type requires adaptation and very specific software that is tailored and is not standardized software that is applicable across all platforms.

In the further embodiment of FIG. 3, the customers 20 are uploaded with standardized customer APP software 22 that communicates with a central server 200 which has massively complex web server software 202 that is able to communicate with a huge variety of service providers 30. Each one is provided with standardized providers APP software 50. Preferably, when a customer activates the APP software 22 she/he is presented with a menu of choices, e.g., represented by icons, which allow the customer to initiate a voice call, or request an appointment at a service provider, e.g., a doctor office, or request an in home (or in business) “home visit” by the service provider.

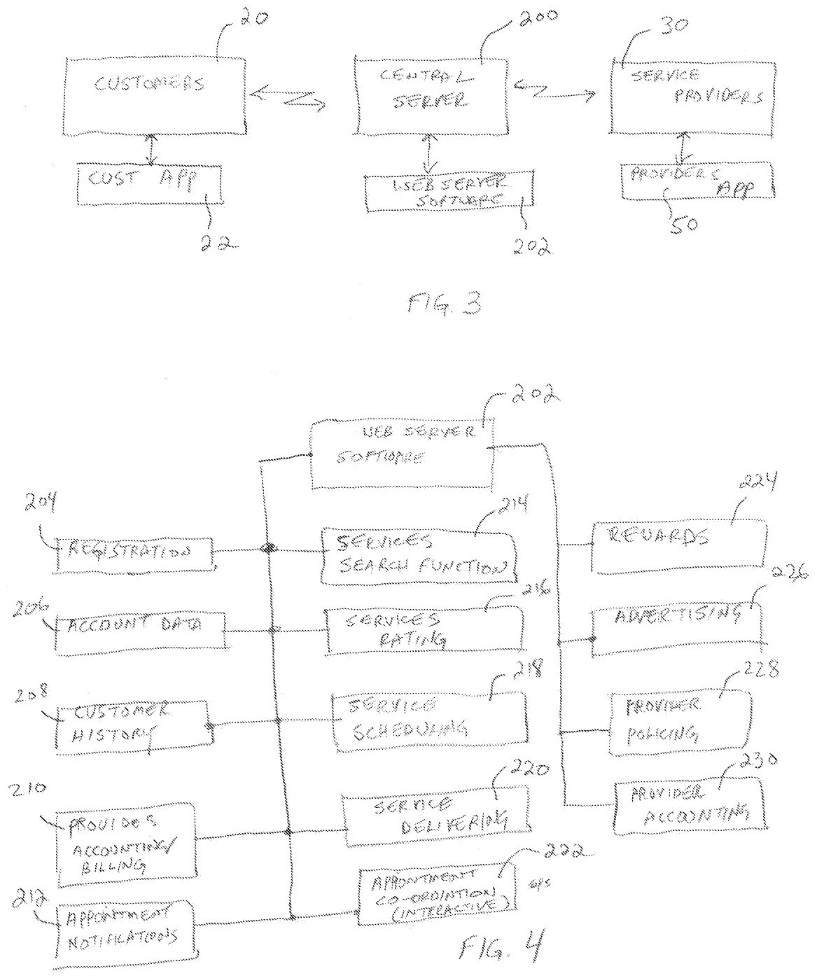

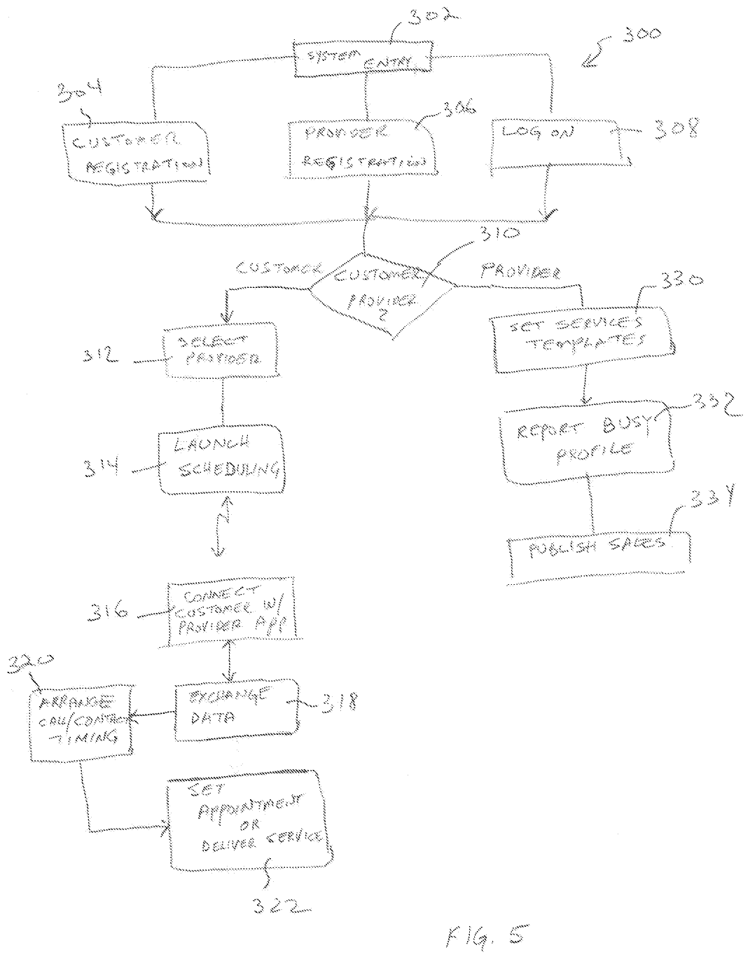

Turning to FIG. 4, the web server software includes a large variety of software modules performing many different functions that can be implemented in hardware and software by persons of ordinary skill in the art of computer hardware and software without undue experimentation and therefore need not be disclosed herein in specific detail.

Thus, the registration module 204 is responsible for new customers registering with the central server 200 so that their personal and specialized information is readily available to any provider that customer might want to reach, which customer similarly has registered with the central server software. Once registered, the customer's or service provider's basic data in terms of accounting records are entered and recorded at the module 206. The module 208 develops a customer history of various service arrangements or calling history that has been experienced by the customer. The provider/accounting billing module 210 can be utilized for the service providers 30 compensating the organization that operates the central server 200 with a fee, for example, a $10.00 fee for a completed arrangement of an appointment or similar arrangement of a service call.

The appointment/notification software module 212 is utilized by the web server software 202 to send specific notifications to customers and to providers of each appointment. Similarly, the appointment coordination module 222 is an interactive software which may employ location detecting GPS software inside the customer APP 22 that informs the service provider, in case the service provider is a medical office or the like of either the location (if permission was granted by the customer), or more likely the proximity or the expected time of arrival of the particular patient or other type of person requiring the delivery of services.

Optimally, as part of the overall web service software 202, also included are other software modules including a search function module 214, that allows customers to actually look for a provider of particular services, for example, automobile services, a medical office or the like and select from a menu of available services after consulting their availabilities, etc. The services rating module 216 allows customers and providers to rate service providers (information that may be kept confidential or optionally published on customer forms and are maintained by the web server software). The service scheduling module 218 indicates the overall functionality of the software components and sections that are responsible and enable customers to call in and set the scheduling appointments. Similarly, the service delivering module 220 can be provided to customers to whom services can be provided via the worldwide web or other communication channels, for example, the delivery of services involving software updates to customers' home or business based computers and the like.

The rewards module 224, as mentioned before, can be included to provide rewards to customers that use the central services, as well as being utilized by providers who may issue rewards to customers that have contacted them or to whom they have provided services. The advertising module 226 can used to defray part of the central server 200 costs by having advertisers place messages that are flashed to customers while customers access the system of the present invention.

The provider policing module 228 can be used to monitor and enforce specific policies of behavior by customers and/or by providers who need to adhere to terms and conditions of the overall system. Finally, with reference to FIG. 4, the provider accounting 230 module may be a billing system that issues invoices through the system directly to a customer as soon as an appointment was completed by interfacing to the internal accounting systems of the service providers.

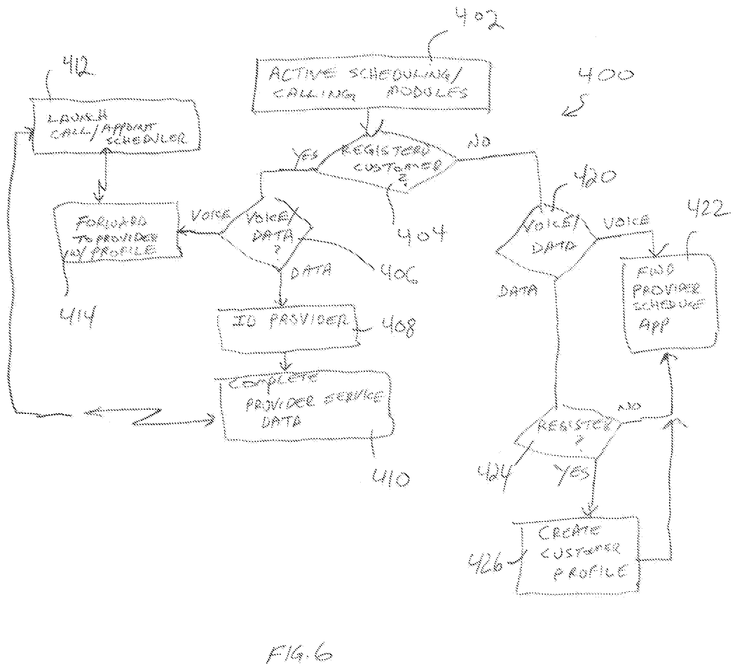

In a typical transaction, and as shown in FIG. 5, a customer may invoke the system entry software 302 which includes among its many software modules a customer registration module 304 that a new customer can use to register with the central server, as previously described. Registration can be automated at time of first purchase of product or service, as a client or patient, etc. Similarly, the provider registration module 306 provides the same function for service providers. Mostly, customers will have already registered and upon entry into the overall interfacing software 300, the customer logs on through the log on module 308 and the software determines at the decisional block 310 whether the call to the service center, which can be either from an ordinary mobile communication device or a data device that accessed the system through a website, is being made by a customer or a provider.

If by a customer, then the select provider module 312 allows the customer to select a provider either by searching the database and selecting a provider or by entering the name of a specific provider. The program then proceeds to the scheduling module 314 which basically handles the previously described scheduling of either a telephone call or a service for the customer in the module 322. As part of that operation, the central system creates a connection with the specific customer to whom at the module 316 at which time the customer is in contact with the provider and information is exchanged at the exchange data module and the arrangement of the call of the service is completed at the module 322.

If on the other hand the call to the call center is from a provider, then the set services template 330 allows a provider to select one of several options including creating various templates that describe the services of the particular provider as part of the overall management function. In the report busy profile module 332, the provider can provide a general indication and upload the business activity level of the particular service provider; so that customers can see at glance without actually calling a particular medical office or automobile repair shop how busy the office is and opt to delay contacting the provider to a later time. In the publish sales module 334, a service provider can perform marketing, advertising and incentives to customers to appear at specific times.

The system of the present invention and specifically the system of FIG. 3 can also include the active scheduling and calling modules 402 which are part of the scheduling system 400 that includes the initial decisional block 404 that decides whether the calling number is a registered customer. If a registered customer, the call is analyzed to determine whether it originates from a voice phone, or from a data phone or device. If voice, the telephone is directly forwarded to the specific provider being called and the provider is immediately provided with the full profile detail of the caller at which point the software module launches calls/appointment scheduler 412 and the call arrangement and/or the call appointment is handled as previously described.

If on the other hand the caller is not a registered customer but rather a new caller, the same decision about voice data is made at the decision module 420. If a voice call, then it is forwarded to the provider at block 422. If it is not a voice call, the caller is prompted to answer whether the caller wants to become registered at block 422 and if yes, then a customer profile is created.

In preferred embodiments, if a call between a customer and a provider is disrupted owing to the passing of the customer through a cellular or WiFi dead zone, the call may be reestablished by a call back call from the provider, according to certain criteria, e.g. within less than 10 minutes, or if the call is re-initiated by the customer or the like.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A time management system comprising:
a plurality of customer communication devices (CCD), each said CCD being configured to allow a customer to place a voice or data communication to a plurality of providers of services, said voice or data communication being associated with a scheduling request requesting the scheduling of a voice call session with said service providers or a rendering by the service providers of a desired service to said customer;
said voice or data communication including customer availability time period or periods; and
a plurality of service providers' communication devices (SPCD), each said SPCD being configured to receive said voice or data communication and to respond thereto by providing a call back time slot or a service performance time period, which takes into account said customer availability time period or periods.

2. The time management system of claim 1, wherein said plurality of customer communication devices communicate directly with said plurality of service providers communication devices, without the intermediary of a central server.

3. The time management system of claim 1, wherein said SPCD is configured to provide to said CCDs information identifying the length of time to be expected before receiving a call back number.

4. The time management system of claim 1, wherein the SPCDs include a facility for calling back said CCDs during said call back time slot.

5. The time management system of claim 1, wherein said communication between said CCDs and said SPCDs is through an IM window or via IVR.

6. The time management system of claim 1, including a facility that configures the SPCDs to receive and store personal profile data associated with said CCDs and historical information about the customers.

7. The time management system of claim 1, further including an intermediary central server that mediates communications between said CCDs and said SPCDs.

8. The time management system of claim 1, wherein said CCD devices comprise APP software that is standardized across said customers, but which enables customization by specific customers to suit each customer's specific needs or requirements.

9. The time management system of claim 1, wherein said SPCDs are controlled by APP service provider software that is standardized across said SPCDs, but which enables individual service providers to tailor and configure the APP service provider software to suit individual needs of said service providers.

10. The time management system of claim 7, wherein said intermediary central server comprises a software controlled system (SCS) that provides a plurality of server functions applicable to said CCDs and to said SPCDs.

11. The time management system of claim 10, wherein said functions include registering customers and service providers with said central server (CS).

12. The time management system of claim 10, wherein said functions include the storing of customer history information.

13. The time management system of claim 10, wherein said functions include the storing of customer history information including accounting and billing for creating billings to service providers for use of the central server.

14. The time management system of claim 10, wherein said functions include providing to customers appointment notifications.

15. The time management system of claim 10, wherein the functions include providing to service providers information that informs the SCS of the time proximity of a given customer to the location of the service provider.

16. The time management system of claim 10, wherein the functions include advertising services of individual service providers.

17. The time management system of claim 10, wherein the functions include a facility that develops statistical information about the time latency between the placement of a call to a service provider and the providing of the time slot for either a telephone call or for a service relative to each service provider that has opted that such data should be developed.

18. The management system of claim 10, including a rating system that enables customers to rate the service provider after such service has been rendered in an anonymous manner.
